(19) United States
(12) Patent Application Publication
(10) Pub. No.: US 2026/0210896 A1
(43) Pub. Date: Jul. 23, 2026

(54) LIQUID SENSOR

(71) Applicant: PILLAR Corporation, Osaka-shi (JP)

(72) Inventors: Yusuke NATSUHARA, Osaka-shi (JP); Akira NAKATSU, Osaka-shi (JP); Kentaro WATANABE, Osaka-shi (JP)

(21) Appl. No.: 19/444,351

(22) Filed: Jan. 9, 2026

(30) Foreign Application Priority Data
Jan. 22, 2025 (JP) 2025-008926

(51) Int. Cl. G01N 27/22

(52) U.S. Cl. CPC G01N 27/226; G01N 27/228

(57) ABSTRACT

A liquid sensor detects the amount of foreign matter in a liquid by immersing at least a portion in the liquid. The liquid sensor includes a first substrate and a second substrate that each includes a first electrode and a second electrode. Each of the first substrate and the second substrate further includes a first detection circuit. The first detection circuit detects the capacitance of a capacitor formed between the first electrode and the second electrode. The foreign matter has a greater influence on the capacitance detected by the first substrate than the capacitance detected by the second substrate. The liquid sensor further includes a second detection circuit. The second detection circuit detects the amount of the foreign matter based on the capacitance detected by the first substrate and the capacitance detected by the second substrate.

### TECHNICAL FIELD

The present invention relates to a liquid sensor.

### BACKGROUND ART

Japanese Patent Application Laid-Open No. 2024-3591 (Patent Document 1) discloses an oil replacement determination and notification device. This oil replacement determination and notification device estimates the amount of contamination mixed in oil and determines the oil replacement timing based on this amount of contamination mixed.

Japanese Patent Application Laid-Open No. 2024-3591 is an example of related art.

### SUMMARY OF THE INVENTION

It is an object of the present invention to provide a liquid sensor capable of realizing relatively high detection sensitivity for foreign matter in a liquid.

A liquid sensor according to an aspect of the present invention detects an amount of foreign matter in a liquid by at least a portion being immersed in the liquid. The liquid sensor includes a first substrate and a second substrate that each include a first electrode and a second electrode. Each of the first substrate and the second substrate further includes a first detection circuit. The first detection circuit detects a capacitance of a capacitor formed between the first electrode and the second electrode. The foreign matter has a greater influence on the capacitance detected by the first substrate than the capacitance detected by the second substrate. The liquid sensor further includes a second detection circuit. The second detection circuit detects the amount of the foreign matter based on the capacitance detected by the first substrate and the capacitance detected by the second substrate.

In this liquid sensor, the amount of the foreign matter is detected based on the capacitance detected by the first substrate and the capacitance detected by the second substrate. Therefore, with this liquid sensor, the foreign matter has different degrees of influences on the capacitances detected by the first substrate and the second substrate, and the amount of the foreign matter is detected in consideration of an influence of a factor other than the foreign matter on the capacitance, thus making it possible to more accurately detect the amount of the foreign matter in the liquid.

In the liquid sensor above, a first end surface of the first electrode and a second end surface of the second electrode may face each other at a predetermined interval, the capacitor may be formed between the first end surface and the second end surface, and the areas of the first end surface and the second end surface and the predetermined interval may satisfy conditions under which an edge effect occurs in the capacitor.

In this liquid sensor, the edge effect occurs in the capacitor formed between the first end surface and the second end surface, and the electric flux lines bulge toward the outside of the capacitor from an end portion of the capacitor on a side opposite to the substrate side. In addition, the edge effect results in an increase in the density of the electric flux lines in the vicinity of the end portion of the capacitor on the side opposite to the substrate. Therefore, with this liquid sensor, the electric flux lines bulge toward the outside of the capacitor and the density of the electric flux lines in the vicinity of the end portion of the capacitor on the side opposite to the substrate increases, thus making it possible to realize a relatively broad detection range and a relatively high detection sensitivity for the foreign matter.

In the liquid sensor above, in a state in which at least the portion is immersed in the liquid, the first substrate may detect the capacitance of the capacitor at a position below the second substrate.

Foreign matter in a liquid often accumulates in a lower portion of the liquid. With this liquid sensor, the first substrate detects the capacitance of the capacitor at a position below the second substrate in a state in which at least a portion of the liquid sensor is immersed in the liquid, and thus the second substrate can detect an influence of a factor other than the foreign matter on the capacitance, thus making it possible to more accurately detect the amount of the foreign matter in the liquid.

A liquid sensor according to another aspect of the present invention detects an amount of foreign matter in a liquid by at least a portion being immersed in the liquid. The liquid sensor includes a substrate and a detection circuit. The substrate includes a first electrode and a second electrode. A first end surface of the first electrode and a second end surface of the second electrode face each other at a predetermined interval. A capacitor is formed between the first end surface and the second end surface. The areas of the first end surface and the second end surface and the predetermined interval satisfy conditions under which an edge effect occurs in the capacitor. The detection circuit detects the amount of the foreign matter based on the capacitance of the capacitor.

In this liquid sensor, the edge effect occurs in the capacitor formed between the first end surface and the second end surface, and the electric flux lines bulge toward the outside of the capacitor from an end portion of the capacitor on a side opposite to the substrate side. In addition, the edge effect results in an increase in the density of the electric flux lines in the vicinity of the end portion of the capacitor on the side opposite to the substrate side. Therefore, with this liquid sensor, the electric flux lines bulge toward the outside of the capacitor and the density of the electric flux lines in the vicinity of the end portion of the capacitor on the side opposite to the substrate side increases, thus making it possible to realize a relatively broad detection range and a relatively high detection sensitivity for foreign matter.

In the liquid sensor above, an open hole may be formed in the first electrode, the second electrode may be disposed inside the open hole, the first end surface may be the inner peripheral surface of the first electrode in the open hole, and the second end surface may be the outer peripheral surface of the second electrode.

With this liquid sensor, it is relatively easy to achieve the edge effect by adjusting the length of each of the inner peripheral surface of the first electrode in the open hole and the outer peripheral surface of the second electrode as well as the interval between the inner peripheral surface of the first electrode in the open hole and the outer peripheral surface of the second electrode.

In the liquid sensor above, a first open hole and a second open hole may be formed in the first electrode, the second electrode may include a first conductor and a second conductor, the first conductor and the second conductor may be disposed inside the first open hole and the second open hole, respectively, the first end surface may include an inner peripheral surface of the first electrode in the first open hole and an inner peripheral surface of the first electrode in the second open hole, and the second end surface may include an outer peripheral surface of the first conductor and an outer peripheral surface of the second conductor.

With this liquid sensor, it is relatively easy to achieve the edge effect by adjusting the length of each of the inner peripheral surface of the first electrode in the first open hole, the inner peripheral surface of the first electrode in the second open hole, the outer peripheral surface of the first conductor, and the outer peripheral surface of the second conductor as well as the interval between the inner peripheral surface of the first electrode in the first open hole and the outer peripheral surface of the first conductor and the interval between the inner peripheral surface of the first electrode in the second open hole and the outer peripheral surface of the second conductor.

With the present invention, it is possible to provide a liquid sensor capable of realizing relatively a high detection sensitivity for foreign matter in a liquid.

### BRIEF DESCRIPTION OF THE DRAWINGS

FIG. 1 is a diagram schematically showing the configuration of an oil sensor according to Embodiment 1.

FIG. 2 is a diagram schematically showing a cross section taken along line II-II in FIG. 1.

FIG. 3 is a plan view schematically showing a substrate.

FIG. 4 is a diagram schematically showing a portion of a cross section taken along line IV-IV in FIG. 3.

FIG. 5 is a partially enlarged perspective view schematically showing a partial region in FIG. 3.

FIG. 6 is a flowchart showing a procedure for producing the substrate.

FIG. 7 is a diagram for describing electric flux lines illustrated between electrodes in a substrate serving as a comparison target.

FIG. 8 is a diagram for describing the electric flux lines illustrated between electrodes in the substrate included in the oil sensor according to Embodiment 1.

FIG. 9 is a flowchart showing a procedure for detecting the amount of contamination mixed in oil.

FIG. 10 is a diagram for describing a procedure for detecting the capacitance between the electrodes.

FIG. 11 is a diagram schematically showing the configuration of an oil sensor according to Embodiment 2.

FIG. 12 is a flowchart showing a procedure for detecting the amount of contamination mixed in oil in Embodiment 2.

FIG. 13 is a diagram for describing another example of the shape of each conductor and another example of the shape of each open hole.

FIG. 14 is a diagram schematically showing another example of the configuration of an oil sensor.

### EMBODIMENTS OF THE INVENTION

The following describes embodiments according to aspects of the present invention (each also referred to as “the present embodiment” hereinafter) in detail with reference to the drawings. Note that the same or corresponding elements in the drawings are denoted by the same reference numerals, and redundant descriptions thereof are omitted. Also, the drawings are schematic drawings in which some elements are omitted or exaggerated as appropriate to facilitate understanding.

### 1. Embodiment 1

### 1-1. Configuration

### (1-1-1. Configuration of Oil Sensor)

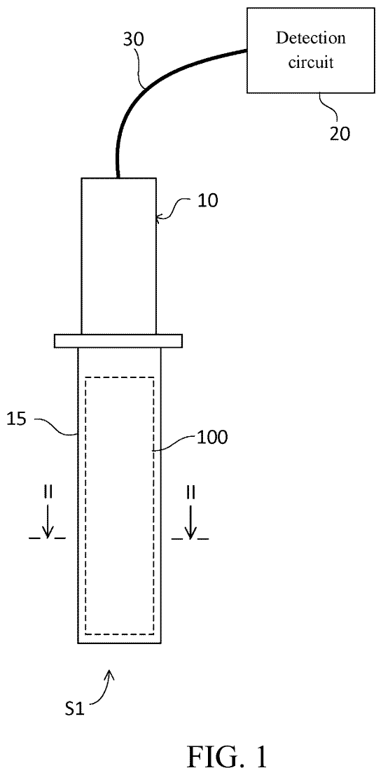

FIG. 1 is a diagram schematically showing the configuration of an oil sensor S1 according to Embodiment 1. The oil sensor S1 is configured to be attached to, for example, the inside of an oil tank of a vehicle or the like and to detect the amount of contamination mixed in fuel (oil) (this amount is also referred to as the “contamination amount” hereinafter). The term “contamination” also encompasses “contaminant”. Examples of the contamination mixed in the oil include soil components including alumina, silica, and the like, iron, water, bubbles, and sludge. The oil sensor S1 is configured to detect the contamination amount in the oil in a state in which at least a portion is immersed in the oil.

As shown in FIG. 1, the oil sensor S1 includes an oil sensor body 10, a detection circuit 20, and a cable 30. In the oil sensor body 10, a substrate 100 is housed inside a plug 15. The substrate 100 and the detection circuit 20 are electrically connected, for example, via the cable 30. The detection circuit 20 includes, for example, a CPU (Central Processing Unit), a RAM (Random Access Memory), and a ROM (Read Only Memory). Note that the substrate 100 and the detection circuit 20 need not necessarily be electrically connected via the cable 30. For example, the substrate 100 and the detection circuit 20 may be substantially electrically connected through mounting of a circuit mounted on the substrate 100 and the detection circuit 20 on the same substate.

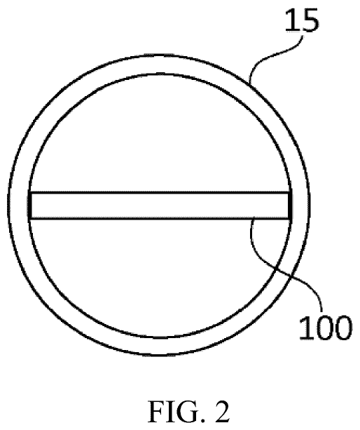

FIG. 2 is a diagram schematically showing a cross section taken along line II-II in FIG. 1. As shown in FIG. 2, the plug 15 has a tubular shape, and the substrate 100 is housed inside the plug 15. Since the plug 15 has a tubular shape, the oil enters the plug 15 in a state in which the oil sensor body 10 is immersed in the oil. Although details will be described below, a plurality of electrodes are formed on the substrate 100. When the contamination amount in the oil changes, the relative permittivity of the oil changes, and as a result, the capacitance between a pair of electrodes included in the plurality of electrodes changes. The detection circuit 20 (see FIG. 1) detects the capacitance between a pair of electrodes by using various known techniques. The detection circuit 20 detects the contamination amount in the oil based on the detected capacitance.

In order to realize a high detection accuracy for the contamination amount in the oil, it is preferable that the capacitance between a pair of electrodes more greatly changes in response to the change in the relative permittivity of the oil. To achieve this, it is preferable to realize a broad detection range and a high detection sensitivity for the contamination in the oil. In the oil sensor S1 according to Embodiment 1, a broad detection range and a high detection sensitivity for the contamination in the oil are realized through an improvement in the configuration of the substrate 100. Next, the configuration of the substrate 100 will be described in detail.

### (1-1-2. Configuration of Substrate)

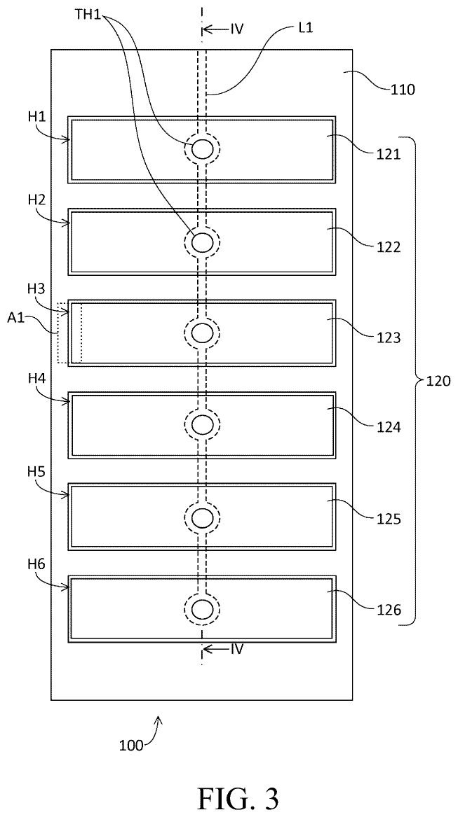

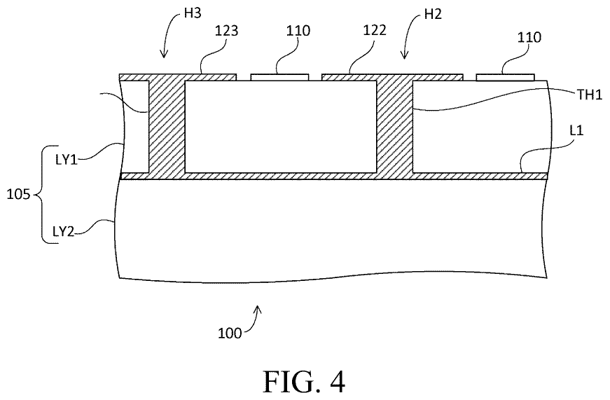

FIG. 3 is a plan view schematically showing the substrate 100. FIG. 4 is a diagram schematically showing a portion of a cross section taken along line IV-IV in FIG. 3. As shown in FIGS. 3 and 4, the substrate 100 has a substantially rectangular shape with long sides and short sides in a plan view. The substrate 100 is a so-called fluororesin substrate. Since the fluororesin substrate has excellent weather resistance and chemical resistance, the substrate 100 can withstand use in a severe environment. Note that the substrate 100 need not necessarily be constituted by a fluororesin substrate, but is preferably constituted by, for example, a substrate with excellent chemical resistance.

The substrate 100 includes a substrate body 105, an electrode 110, and an electrode 120. The substrate body 105 is constituted by the above-described fluororesin substrate and includes a plurality of layers including a layer LY1 and a layer LY2. For example, a plurality of through holes TH1 are formed in the layer LY1, and a line L1 is formed on the layer LY2. The through holes TH1 and the line L1 are electrically connected. The electrodes 110 and 120 are formed on the substrate body 105, and are made of, for example, a conductive material such as gold, silver, copper, or aluminum.

The electrode 110 has a substantially rectangular shape with long sides and short sides. A plurality of open holes (an open hole H1, an open hole H2, an open hole H3, an open hole H4, an open hole H5, and an open hole H6) are formed in the electrode 110. Each of the open holes H1 to H6 has a substantially rectangular shape with long sides and short sides. The electrode 120 includes a plurality of conductors (a conductor 121, a conductor 122, a conductor 123, a conductor 124, a conductor 125, and a conductor 126). Each of the conductors 121 to 126 has a substantially rectangular shape with long sides and short sides. The sizes of the conductors 121 to 126 are slightly smaller than the sizes of the open holes H1 to H6, respectively. The conductors 121 to 126 are disposed inside the open holes H1 to H6, respectively. The electrode 110 is connected to one pole of a power source (not illustrated), and the conductors 121 to 126 are connected to the other pole of the power source via the through holes TH1 and the line L1. Thus, a voltage is applied between the electrodes 110 and 120.

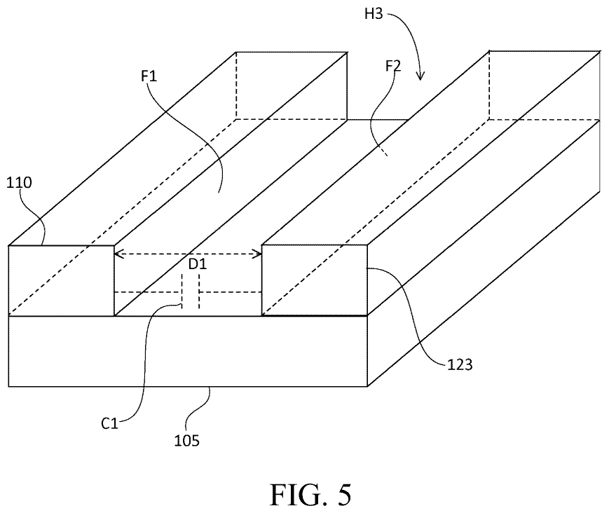

FIG. 5 is a partially enlarged perspective view schematically showing a partial region A1 in FIG. 3. As shown in FIG. 5, an end surface F1 that is a portion of the inner peripheral surface of the electrode 110 in the open hole H3, and an end surface F2 that is a portion of the outer peripheral surface of the conductor 123 (a portion corresponding to one side of the conductor 123) face each other at a predetermined interval D1. When a voltage is applied between the electrodes 110 and 120, a capacitor C1 is formed between the end surfaces F1 and F2. Although details will be described below, the areas of the end surfaces F1 and F2 and the predetermined interval D1 satisfy the conditions under which the edge effect occurs in the capacitor C1. That is to say, a relationship “area of end surface F2>> predetermined interval D1” is not satisfied. A reason why the areas of the end surfaces F1 and F2 and the predetermined interval D1 are designed such that the edge effect occurs in the capacitor C1 will be described in detail below.

Referring back to FIG. 3, the areas of the end surfaces included in the outer peripheral surface of the conductor 121 and the interval between the inner peripheral surface of the electrode 110 in the open hole H1 and the outer peripheral surface of the conductor 121 satisfy the conditions under which the edge effect occurs in the capacitors formed between the end surfaces facing each other. The same applies to a relationship between the outer peripheral surface of the conductor 122 and the inner peripheral surface of the electrode 110 in the open hole H2, a relationship between the outer peripheral surface of the conductor 123 and the inner peripheral surface of the electrode 110 in the open hole H3, a relationship between the outer peripheral surface of the conductor 124 and the inner peripheral surface of the electrode 110 in the open hole H4, a relationship between the outer peripheral surface of the conductor 125 and the inner peripheral surface of the electrode 110 in the open hole H5, and a relationship between the outer peripheral surface of the conductor 126 and the inner peripheral surface of the electrode 110 in the open hole H6.

### 1-2. Method for Producing Substrate

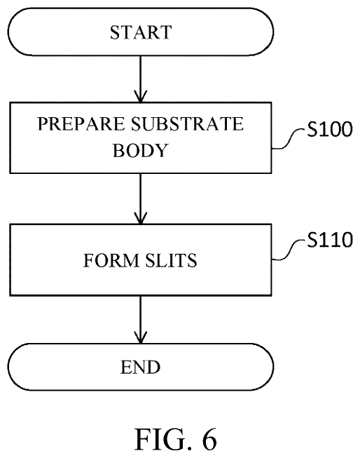

FIG. 6 is a flowchart showing a procedure for producing the substrate 100. As shown in FIG. 6, first, the substrate body 105 in which a layer made of a conductive material (also referred to as a “conductive material layer” hereinafter) is formed throughout at least one principal surface is prepared (Step S100). In the substrate body 105, the plurality of through holes TH1 and the line L1 are formed in advance. An apparatus for producing the substrate 100 forms slits in the conductive material layer of the prepared substrate body 105 (Step S110). The production apparatus forms the slits in the conductive material layer through, for example, etching. Due to the slits being formed in the conductive material layer, each of the conductors 121 to 126 is spaced apart from the electrode 110, and thus each of the conductors 121 to 126 and the electrode 110 are electrically separated from each other. The substrate 100 is thus completed.

### 1-3. Realization of Broad Detection Range and High Detection Sensitivity

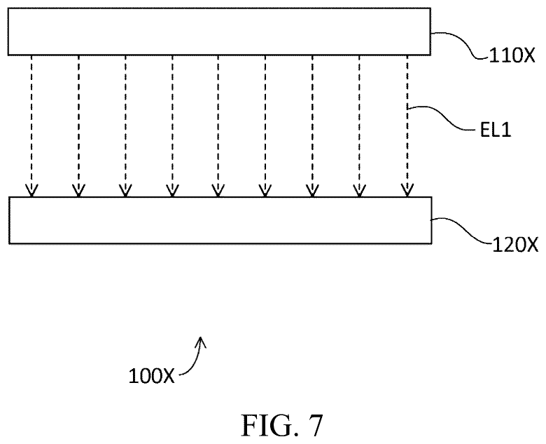

FIG. 7 is a diagram for describing electric flux lines EL1 illustrated between electrodes 110X and 120X in a substrate 100X serving as a comparison target. As shown in FIG. 7, in the substrate 100X, the electrode 110X and the electrode 120X face each other. When a voltage is applied between the electrodes 110X and 120X, a capacitor is formed between the electrodes 110X and 120X.

The areas of the electrodes 110X and 120X and the length between the electrodes 110X and 120X do not satisfy the conditions under which the edge effect occurs in this capacitor. That is to say, a relationship “areas of electrodes 110X and 120X>>length between electrodes 110X and 120X” is satisfied. Accordingly, the electric flux lines EL1 illustrated between the electrodes 110X and 120X linearly extend from the electrode 110X to the electrode 120X. In this case, contamination located between the electrodes 110X and 120X is detected, but the contamination detection range is not necessarily broad, and the contamination detection sensitivity is not necessarily high.

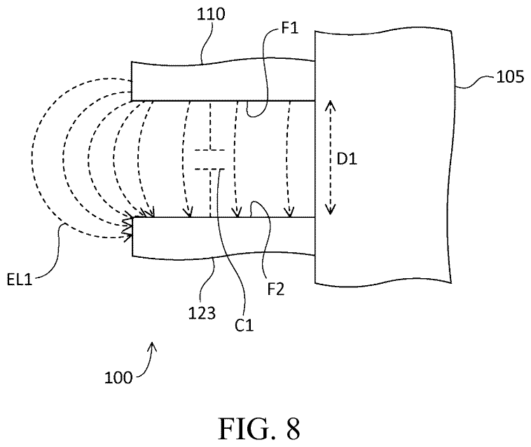

FIG. 8 is a diagram for describing the electric flux lines EL1 illustrated between the electrodes 110 and 120 in the substrate 100 included in the oil sensor S1 according to Embodiment 1. As shown in FIG. 8, as described above, the end surface F1 of the electrode 110 and the end surface F2 of the conductor 123 (electrode 120) face each other, and the capacitor C1 is formed between the electrode 110 and the conductor 123 through the application of a voltage between the electrodes 110 and 120.

The areas of the end surfaces F1 and F2 and the predetermined interval D1 satisfy the conditions under which the edge effect occurs in the capacitor C1. Accordingly, the electric flux lines EL1 bulge toward the outside of the capacitor C1 from an end portion of the capacitor C1 on a side opposite to the substrate body 105 side. In addition, the edge effect results in an increase in the density of the electric flux lines EL1 in the vicinity of the end portion of the capacitor C1 on the side opposite to the substrate body 105 side. Contamination in the oil is often present in a space outside a space (slit portion) between the electrode 110 and the conductor 123 rather than the space between the electrode 110 and the conductor 123. Therefore, with the substrate 100, the electric flux lines EL1 bulge toward the outside of the capacitor C1 and the density of the electric flux lines EL1 in the vicinity of the end portion of the capacitor C1 on the side opposite to the substrate body 105 side increases, thus making it possible to realize a relatively broad detection range and a relatively high detection sensitivity for the contamination in the oil.

### 1-4. Operation

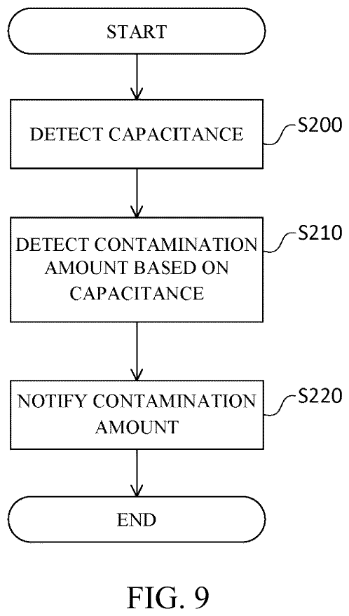

FIG. 9 is a flowchart showing a procedure for detecting the amount of contamination mixed in oil in Embodiment 1. For example, the process shown in this flowchart is carried out in a predetermined cycle by the detection circuit 20 with a voltage being applied between the electrodes 110 and 120.

As shown in FIG. 9, the detection circuit 20 detects the capacitance between the electrodes 110 and 120 by detecting the capacitances of the capacitors formed between the electrodes 110 and 120 and calculating the sum of the capacitances (Step S200).

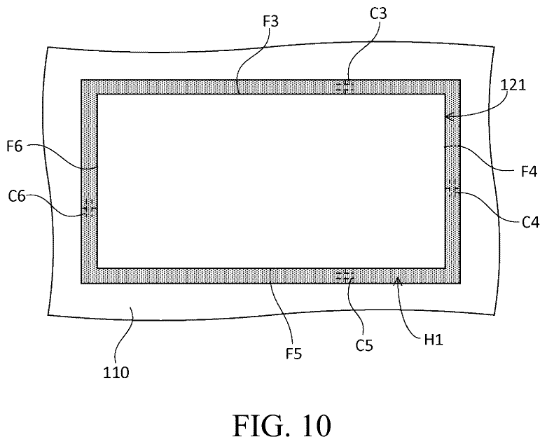

FIG. 10 is a diagram for describing a procedure for detecting the capacitance between the electrodes 110 and 120. As shown in FIG. 10, for example, on the periphery of the conductor 121 included in the electrode 120, a capacitor C3 is formed between an end surface F3 of the conductor 121 and the inner peripheral surface of the substrate 100, and a capacitor C4 is formed between an end surface F4 of the conductor 121 and the inner peripheral surface of the substrate 100. Also, a capacitor C5 is formed between an end surface F5 of the conductor 121 and the inner peripheral surface of the substrate 100, and a capacitor C6 is formed between an end surface F6 of the conductor 121 and the inner peripheral surface of the substrate 100. The capacitance between the electrode 110 and the conductor 121 is the sum of the capacitances of the capacitors C3, C4, C5, and C6. Similarly, the capacitances between the respective conductors 122, 123, 124, 125, and 126 and the electrode 110 are calculated. The sum of the capacitances between the respective conductors 121, 122, 123, 124, 125, and 126 and the electrode 110 is taken as the capacitance between the electrodes 110 and 120.

Referring back to FIG. 9, when the capacitance between the electrodes 110 and 120 is detected, the detection circuit 20 detects the contamination amount in the oil based on the capacitance between the electrodes 110 and 120 (Step S210). The relationship between the capacitance between the electrodes 110 and 120 immersed in the oil and the contamination amount in the oil is determined in advance through experiments, and the detection circuit 20 stores the information on this relationship (also referred to as “first relationship information” hereinafter). The detection circuit 20 estimates the contamination amount in the oil from the capacitance between the electrodes 110 and 120 by referring to the first relationship information. The detection circuit 20 notifies the information on the detected contamination amount (also referred to as “contamination amount information” hereinafter) to the outside of the oil sensor S1 (Step S220). The notified contamination amount information is displayed on, for example, a display outside the oil sensor S1.

### 1-5. Features

As described above, in the oil sensor S1 according to Embodiment 1, the edge effect occurs in the capacitor formed between the end surface of the electrode 110 and the end surface of the electrode 120, and the electric flux lines EL1 bulge toward the outside of the capacitor from an end portion of the capacitor on a side opposite to the substrate body 105 side. In addition, the edge effect results in an increase in the density of the electric flux lines EL1 in the vicinity of the end portion of the capacitor on the side opposite to the substrate body 105 side. Therefore, with the oil sensor S1, the electric flux lines EL1 bulge toward the outside of the capacitor and the density of the electric flux lines EL1 in the vicinity of the end portion of the capacitor on the side opposite to the substrate body 105 side increases, thus making it possible to realize a relatively broad detection range and a relatively high detection sensitivity for contamination.

### 2. Embodiment 2

### 2-1. Configuration of Oil Sensor

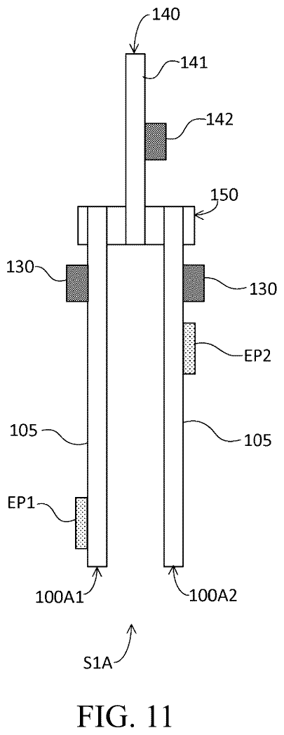

FIG. 11 is a diagram schematically showing the configuration of an oil sensor S1A according to Embodiment 2. The oil sensor S1A is configured to be attached to, for example, the inside of an oil tank of a vehicle or the like and to detect the contamination amount in fuel (oil). The oil sensor S1A is configured to detect the contamination amount in oil in a state in which at least a portion is immersed in the oil.

As shown in FIG. 11, the oil sensor S1A includes a substrate 100A1, a substrate 100A2, a substrate 140, and a connector 150. The substrate 100A1 includes a substrate body 105, an electrode pattern EP1, and a detection circuit 130. In the substrate 100A1, the electrode pattern EP1 is formed on the substrate body 105, and the detection circuit 130 is mounted on the substrate body 105. The electrode pattern EP1 has substantially the same configuration as the electrodes 110 and 120 included in the oil sensor S1 according to Embodiment 1 above. The detection circuit 130 includes, for example, a CPU, a RAM, and a ROM.

The substrate 100A2 includes a substrate body 105, an electrode pattern EP2, and a detection circuit 130. In the substrate 100A2, the electrode pattern EP2 is formed on the substrate body 105, and the detection circuit 130 is mounted on the substrate body 105. The electrode pattern EP2 has substantially the same configuration as the electrodes 110 and 120 included in the oil sensor S1 according to Embodiment 1 above. The substrate 100A1 and the substrate 100A2 are different from each other in the position of the electrode pattern in the state in which the oil sensor S1A is immersed in the oil. That is to say, the electrode pattern EP1 of the substrate 100A1 is located below the electrode pattern EP2 of the substrate 100A2 in the state in which the oil sensor S1A is immersed in the oil.

The substrate 140 includes a substrate body 141 and a detection circuit 142. The substrate body 141 is constituted by, for example, a fluororesin substrate. In the substrate 140, the detection circuit 142 is mounted on the substrate body 141. The detection circuit 142 includes, for example, a CPU, a RAM, and a ROM. The connector 150 electrically connects the substrates 100A1, 100A2 and 140 to one another.

### 2-2. Realization of High Detection Accuracy for Contamination Amount in Oil

The relative permittivity of oil may change due to a factor (e.g., the degree of deterioration of the oil or the temperature of the oil) other than contamination in the oil. Therefore, in order to more accurately detect the contamination amount in the oil, it is preferable to isolate an influence of contamination on the change in the relative permittivity of the oil from all the influences thereon.

Contamination in oil often accumulates in a lower portion of the oil. In the oil sensor S1A according to Embodiment 2, the substrate 100A1 detects the capacitance of a capacitor formed in the electrode pattern EP1 located at a lower position, and the substrate 100A2 detects the capacitance of a capacitor formed in the electrode pattern EP2 located at an upper position. Given contamination accumulates mainly in a lower portion of oil, both a change in the relative permittivity of the oil caused by the contamination and a change in the relative permittivity of the oil caused by a factor other than the contamination have a great influence on the capacitance detected by the substrate 100A1. Meanwhile, a change in the relative permittivity of the oil caused by a factor other than the contamination mainly has an influence on the capacitance detected by the substrate 100A2.

In Embodiment 2, the contamination amount in the oil is detected based on both the capacitance detected by the substrate 100A1 and the capacitance detected by the substrate 100A2. Therefore, with the oil sensor S1A, the contamination amount is detected in consideration of an influence of a factor other than the contamination on the capacitance, thus making it possible to more accurately detect the contamination amount in the oil.

### 2-3. Operation

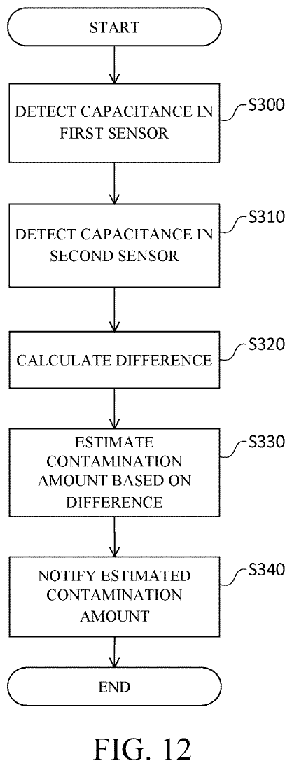

FIG. 12 is a flowchart showing a procedure for detecting the amount of contamination mixed in oil in Embodiment 2. For example, the process shown in this flowchart is carried out in a predetermined cycle by the detection circuits 130 and 142 with a voltage being applied between the electrodes included in each of the electrode patterns EP1 and EP2.

As shown in FIG. 12, the detection circuit 130 included in the substrate 100A1 detects the capacitance between the electrodes in the electrode pattern EP1, and transmits a signal indicating the detected capacitance to the detection circuit 142 (Step S300). The detection circuit 130 included in the substrate 100A2 detects the capacitance between the electrodes in the electrode pattern EP2, and transmits a signal indicating the detected capacitance to the detection circuit 142 (Step S310). The detection circuit 142 calculates a difference between the capacitance detected in the substrate 100A1 and the capacitance detected in the substrate 100A2 (Step S320).

The detection circuit 142 estimates the contamination amount in the oil based on the calculated difference (Step S330). The relationship between the capacitance difference and the contamination amount in the oil is determined in advance through experiments, and the detection circuit 142 stores the information on this relationship (also referred to as “second relationship information” hereinafter). The detection circuit 142 estimates the contamination amount in the oil from the calculated capacitance by referring to the second relationship information. The detection circuit 142 notifies the information on the estimated contamination amount to the outside of the oil sensor S1A (Step S340). The notified information is displayed on, for example, a display outside the oil sensor S1A. Also, an alert may be displayed on the display when the estimated contamination amount exceeds a predetermined amount.

### 2-4. Features

As described above, in the oil sensor S1A according to Embodiment 2, the contamination amount is detected based on the capacitance detected by the substrate 100A1 and the capacitance detected by the substrate 100A2. Therefore, with the oil sensor S1A, the contamination amount is estimated in consideration of an influence of a factor other than the contamination on the capacitance, thus making it possible to more accurately detect the contamination amount in the oil.

### 3. Other Embodiments

The ideas of the embodiments above are not limited to the embodiments described above. The following describes examples of other embodiments to which the ideas of the embodiments above are applicable.

### 3-1

In Embodiment 1 above, the shapes of the electrodes 110 and 120 are not limited to the shapes above. For example, the conductors included in the electrode 120 need not have a substantially rectangular shape, and the open holes formed in the electrode 110 need not have a substantially rectangular shape.

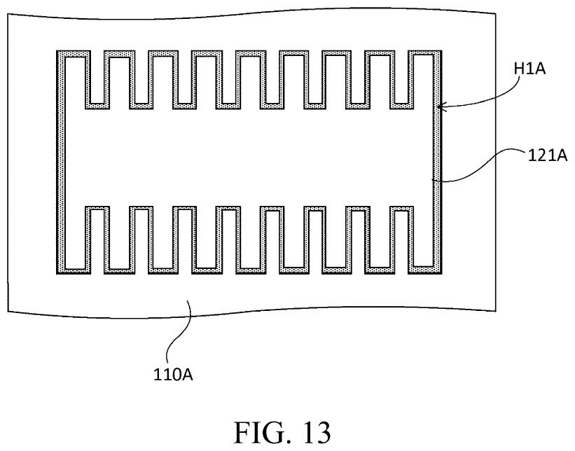

FIG. 13 is a diagram for describing another example of the shape of each conductor and another example of the shape of each open hole. As shown in FIG. 13, an open hole H1A is formed in an electrode 110A. A conductor 121A is disposed inside the open hole H1A. A plurality of protrusions and recessed portions are formed on the outer peripheries of the open hole H1A and the conductor 121A. Thus, when a voltage is applied between the electrode 110A and the conductor 121A, the number of capacitors formed between the electrode 110A and the conductor 121A is increased compared with the case where the electrode and the conductor have a substantially rectangular shape. This results in an increase in the contamination amount detection sensitivity.

### 3-2

In Embodiment 2 above, the position of the electrode pattern EP1 in the height direction and the position of the electrode pattern EP2 in the height direction are different from each other. As a result, contamination has different degrees of influences on the capacitances detected by the substrate 100A1 and the substrate 100A2. However, a factor that contamination has different degrees of influences on the capacitances detected by the substrate 100A1 and the substrate 100A2 is not limited to the position of the electrode pattern in the height direction.

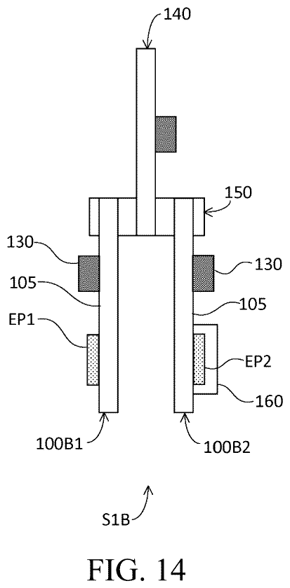

FIG. 14 is a diagram schematically showing another example of the configuration of an oil sensor. As shown in FIG. 14, the oil sensor S1B includes a substrate 100B1, a substrate 100B2, and a substrate 140. The position of the electrode pattern EP1 on the substrate 100B1 in the height direction and the position of the electrode pattern EP2 on the substrate 100B2 in the height direction are the same. In the substrate 100B2, the upper portion of the electrode pattern EP2 is covered by a recessed enclosure 160. The enclosure 160 does not prevent infiltration of the oil but prevents entrance of contamination. As a result, both a change in the relative permittivity of the oil caused by the contamination and a change in the relative permittivity of the oil caused by a factor other than the contamination have a great influence on the capacitance detected by the substrate 100B1. Meanwhile, a change in the relative permittivity of the oil caused by a factor other than the contamination mainly has an influence on the capacitance detected by the substrate 100B2. The configuration of the oil sensor according to Embodiment 2 above may be a configuration as shown in FIG. 14.

### 3-3

In Embodiments 1 and 2 above, the contamination amount in the oil is detected. However, the amount of foreign matter other than contamination in a liquid other than the oil may be detected, the amount of foreign matter other than the contamination in the oil may be detected, or the contamination amount in a liquid other than the oil may be detected.

### 3-4

In Embodiments 1 and 2 above, it is sufficient that the contamination amount is detected based on the capacitance between the electrodes. For example, the contamination amount may be estimated directly from the capacitance between the electrodes, or the contamination amount may be estimated from the relative permittivity of the oil that has been calculated in advance from the capacitance between the electrodes.

Example embodiments of the present invention have been described above. That is to say, the detailed description and the appended drawings are disclosed for purposes of illustration. Accordingly, constituent elements described in the detailed description or shown in the appended drawings may include constituent elements that are not essential to solve the problem. Therefore, even if such non-essential constituent elements are described in the detailed description or shown in the appended drawings, those non-essential constituent elements should not be immediately deemed to be essential.

Also, the embodiments above are merely examples of the present invention in all aspects. Various modifications and alterations can be made on the embodiments above within the scope of the present invention. For example, at least one configuration of any of the embodiments may be combined with at least one configuration of the other embodiments. That is to say, specific configurations may be adopted as appropriate according to the manner of implementation of the present invention.

### LIST OF REFERENCE NUMERALS

10 Oil sensor body
15 Plug
20, 130, 142 Detection circuit
30 Cable
100, 140 Substrate
105, 141 Substrate body
110, 120 Electrode
121, 122, 123, 124, 125, 126 Conductor
150 Connector
160 Enclosure
A1 Region
C1, C3, C4, C5, C6 Capacitor
D1 Predetermined interval
EL1 Electric flux line
EP1, EP2 Electrode pattern
F1, F2, F3, F4, F5, F6 End surface
H1, H2, H3, H4, H5, H6 Open hole
L1 Line
LY1, LY2 Layer
S1 Oil sensor
TH1 Through hole

1. A liquid sensor for detecting an amount of foreign matter in a liquid by at least a portion being immersed in the liquid, the liquid sensor comprising:
a first substrate and a second substrate that each include a first electrode and a second electrode,
wherein each of the first substrate and the second substrate further includes a first detection circuit for detecting a capacitance of a capacitor formed between the first electrode and the second electrode,
the foreign matter has a greater influence on the capacitance detected by the first substrate than the capacitance detected by the second substrate, and
a second detection circuit for detecting the amount of the foreign matter based on the capacitance detected by the first substrate and the capacitance detected by the second substrate is further included.

2. The liquid sensor according to claim 1,
wherein a first end surface of the first electrode and a second end surface of the second electrode face each other at a predetermined interval,
the capacitor is formed between the first end surface and the second end surface, and
areas of the first end surface and the second end surface and the predetermined interval satisfy conditions under which an edge effect occurs in the capacitor.

3. The liquid sensor according to claim 2, wherein in a state in which at least the portion is immersed in the liquid, the first substrate detects the capacitance of the capacitor at a position below the second substrate.

4. A liquid sensor for detecting an amount of foreign matter in a liquid by at least a portion being immersed in the liquid, the liquid sensor comprising:
a substrate that includes a first electrode and a second electrode,
wherein a first end surface of the first electrode and a second end surface of the second electrode face each other at a predetermined interval,
a capacitor is formed between the first end surface and the second end surface,
areas of the first end surface and the second end surface and the predetermined interval satisfy conditions under which an edge effect occurs in the capacitor, and
a detection circuit for detecting the amount of the foreign matter based on a capacitance of the capacitor is further included.

5. The liquid sensor according to claim 4,
wherein an open hole is formed in the first electrode,
the second electrode is disposed inside the open hole,
the first end surface is an inner peripheral surface of the first electrode in the open hole, and
the second end surface is an outer peripheral surface of the second electrode.

6. The liquid sensor according to claim 4,
wherein a first open hole and a second open hole are formed in the first electrode,
the second electrode includes a first conductor and a second conductor,
the first conductor and the second conductor are disposed in the first open hole and the second open hole, respectively,
the first end surface includes an inner peripheral surface of the first electrode in the first open hole and an inner peripheral surface of the first electrode in the second open hole, and
the second end surface includes an outer peripheral surface of the first conductor and an outer peripheral surface of the second conductor.
